(19) United States
(12) Patent Application Publication
(10) Pub. No.: US 2024/0355211 A1
(43) Pub. Date: Oct. 24, 2024

(54) SYSTEMS FOR AND METHODS OF INCREASING ELECTRIC VEHICLE UTILIZATION IN TRANSIT FLEETS USING LEARNING, PREDICTIONS, OPTIMIZATION, AND AUTOMATION

(71) Applicant: AV-Connect, Inc., Alameda, CA (US)

(72) Inventors: Bruce Wootton, Alameda, CA (US); Jacopo Guanetti, Berkeley, CA (US); Yeojun Kim, Oakland, CA (US)

(21) Appl. No.: 18/635,529

(22) Filed: Apr. 15, 2024

Related U.S. Application Data
(60) Provisional application No. 63/459,167, filed on Apr. 13, 2023.

(51) Int. Cl. G08G 1/00; G08G 1/01; G08G 1/09; H04L 67/12

(52) U.S. Cl. CPC G08G 1/20; G08G 1/0112; G08G 1/0116; G08G 1/0129; G08G 1/0145; G08G 1/091; H04L 67/12

(57) ABSTRACT

A hierarchical system increases the utilization of a fleet of Battery Electric Buses (BEBs) by optimally assigning work to and providing charging strategies for the BEBs. The system includes a digital twin platform for generating behavior models for the electric vehicles, charging stations for the electric vehicles, or both; an assignment and strategy module for optimally assigning blocks and determining optimal charging strategies for the electric vehicles; and a depot parking and management module for parking and charging the electric vehicles according to optimal charging strategies. In some embodiments, the behavior models can be adjusted in real time in response to the occurrences of events.

### RELATED APPLICATION(S)

This application claims priority under 35 U.S.C. § 119 (e) of the co-pending U.S. Provisional Patent Application Ser. No. 63/459,167, filed Apr. 13, 2023, and titled “Increasing Electric Vehicles Utilization in Transit Fleets Using Learning, Predictions, Optimization, and Automation,” which is hereby incorporated by reference in its entirety.

### GOVERNMENT LICENSE RIGHTS

This invention was made with government support under (1) DE-AR0000791 awarded by ARPA-E NEXTCAR Program, (2) Grant 2019458 awarded by National Science Foundation, and (3) Grant DE-SC0020894 awarded by the Department of Energy, Office of Science. The government has certain rights in the invention.

### FIELD OF THE INVENTION

This invention is related to management systems for electric transit fleets. More specifically, this invention is related to dynamically optimizing operations through learning-based models to predict costs and guide assignment decisions in real time.

### BACKGROUND OF THE INVENTION

For the past few years, transportation has become the largest polluter of Greenhouse Gas Emissions (GHG) in the United States. Electrification is the primary solution to the decarbonization of transportation. Governments around the world are encouraging electric mobility by enacting regulations and providing funds to road transit authorities to transition their fleets to zero-emission vehicles (ZEV).

The operation of ZEVs has its own challenges. For example, (1) ZEVs have range (mileage) limitations corresponding to their battery capacities. (2) Recharging can take hours, taking the ZEVs offline for longer times than are required to refuel internal combustion engine (ICE) vehicles. Recharging can only take place at specific locations where chargers are available; thus, refueling must be planned. (3) ZEV battery capacities change of time, as the battery characteristics change. (4) The cost of charging varies throughout the day, increasing from partial-peak and off-peak hours to peak hours (electric tariffs), imposing increased cost when charging at peak hours.

And while transit authorities (“agencies”) have been deploying small numbers of ZEVs, they must account for these limitations. As these agencies embark on transitioning a significant percentage of their fleet to ZEVs, they are becoming highly focused on strategies to efficiently and cost-effectively meet service requirements designed around conventional vehicles, using zero-emission technology. In transit agencies with a fixed schedule, a “trip” covers a certain sequence of stops at pre-defined times, each visiting a set of stop locations that will be served each day of the week for a certain period of time (typically for a few months), so that the corresponding bus stop locations are visited at pre-defined arrival and departure times. In this context, a trip refers to a route being driven at a certain time of day each day of the week along a specific route. The goal of planning is to identify the stops and trips necessary to satisfy public demand, maximize service, minimize operator cost, and meet the fleet size and operator headcount.

Normally, trips that are adjacent in space and time are organized into “blocks,” units of work to be performed by a certain bus and driver. Blocks generally start and end in one or few locations (parking lots and depots with maintenance, fueling, and charging infrastructure) and are designed with driver shifts in mind and with a goal to serve all trips while minimizing the non-revenue miles driven between trips that start and end at different locations (“deadheading”). Normally, drivers pick their blocks at each schedule change. A good block minimizes deadheading. At the same time, a block should normally be feasible for the driving range of a single bus and for the working hours of a single driver.

Blocks are designed, however, primarily with diesel buses in mind, and it is possible for such blocks to be unfeasible for Battery Electric Buses (BEBs), particularly in challenging environmental conditions such as winter operation in cold regions. In general, ZEVs include BEBs as well as other clean fuel vehicles such as hydrogen vehicles. To simplify the following discussion below, the term ZEV will be used as a synonym for BEB.

Concerns in transitioning from ICE vehicles to ZEVs relate to minimizing the need for fleet size expansions, strategically modifying blocks to complete scheduled service with ZEVs, and the capital and operational expenses required to convert to ZEVs. All of these challenges are intrinsically related to the ability (1) to increase utilization of zero-emission buses, given the limited and variable range possible with the vehicles, and (2) to strategize and manage charging activities to avoid non-linear electricity cost increases associated with high power demand.

Uncertainty and variability of both driving range and time required to recharge are major hurdles for transit agencies in planning for and operating BEBs. Driving range can vary by a factor of 5 depending on a host of conditions, including temperature and other weather parameters, traffic, route profile, driving behavior, occupancy, and the configuration and condition of the vehicle and its components (such as battery aging). The inability to accurately predict the energy and charging time required for each anticipated piece of work forces transit agencies to trade off the reliability and cost-effectiveness of their operating service. Ultimately, due to the critical need for reliable service, transit agencies err extremely conservatively, thus anticipating the need for significantly expanded fleet sizes, electrical infrastructure for charging, onboard battery packs, and electricity cost. All of the above needs would be mitigated if range and charging uncertainty could be reduced.

Currently, transit agencies cannot predict with high precision (nor take into account a continuously changing context) the charge depletion of a BEB along a route or the time to charge its battery to a certain level. Instead, the agencies rely on simplistic, nominal estimates of miles-per-gallon-equivalent (MPGe) and miles-per-charge, calculated by observing the change in the battery State of Charge (SoC) and the miles driven. Consequently, they have to be very conservative when assigning blocks to their BEBs, which results in reduced utilization and in increased operating costs and capital expenditures of their BEB fleets.

Thus, there is a need to more accurately predict charge depletion of a BEB along a route, predict the time to charge a battery to a predetermined level, assign charging schedules to optimally charge BEBs, or any combination of these goals.

### SUMMARY OF THE INVENTION

In a first aspect, a system assigns work to and charging electric vehicles from a fleet of electric vehicles. The system includes a digital twin platform for generating behavior models for electric vehicles, charging stations for the electric vehicles, or both; an assignment and strategy module for optimally assigning blocks and determining optimal charging strategies for the electric vehicles; and a depot parking and management module for parking and charging the electric vehicles according to optimal charging strategies. In some embodiments, the digital twin platform includes a behavior model module for generating the behavior models, the behavior model module including an automated learning element to update the behavior models. In some embodiments, the automated learning element updates the behavior models in real time. The models include physics-based models, neural network-based models, or any combination of both.

In some embodiments, the system further includes an input module coupled to the digital twin platform. The input module is configured to transmit to the digital twin platform telematics information associated with the electric vehicles, the chargers, or any combination thereof.

In some embodiments, the system further includes a third-party input module coupled to the digital twin platform for transmitting traffic data, weather data, and maps data to the digital twins platform.

In some embodiments, the assignment and strategy module is configured to solve an optimization problem based on state of charge for electric batteries for the electric vehicles, initial and final state constraints for the electric vehicles, safe battery operation constraints for the electric vehicles, charging constraints for chargers at a depot, bus-to-block constraints, or any combination thereof. The assignment and strategy module is further configured to assign the blocks, determine the optimal charging strategies based on a price of electricity, a maximum power supply, the availability of chargers, or any combination thereof.

In some embodiments, the system further comprises a replanning platform that includes a prediction module coupled to an adaptive optimization module. In some embodiments, the prediction module includes a Deep Reinforcement Learning-Based Cost Prediction module with real-time feedback coupled to an Adaptive Optimization System using a real-time trigger.

In some embodiments, the digital twin platform, the assignment and strategy module, the depot parking and management module, or any combination thereof are hosted on a cloud platform. In some embodiments, the digital twin platform, the assignment and strategy module, the depot parking and management module, or any combination thereof comprises a processor and computer-executable instructions that when executed by the processor perform the corresponding functions.

In a second aspect, a method of efficiently utilizing electric vehicles in a transit fleet includes generating behavior models for the electric vehicles, vehicle charging stations, or both; optimizing the performances of the electric vehicles, vehicle charging stations, or both based at least in part on vehicle constraints, charging constraints, or both; and controlling the deployment and charging of the electric vehicles based on the behavior models. In some embodiments, the method also includes generating a vehicle behavior model for each individual electric vehicle or generating a vehicle behavior model for each type of vehicle.

In some embodiments, the behavior models are learning based. In some embodiments, the optimizing are based at least in part on Deep Reinforcement Learning (DRL)-based cost prediction models. The DRL-based cost prediction models dynamically predict dispatching costs by considering vehicle states, operational parameters, and environmental conditions.

In some embodiments, optimizing includes solving one or more optimization problems. In some embodiments, solving the optimization problem is triggered by the occurrence of one or more events, including a low vehicle state of charge, scheduled intervals, and a detected discrepancy between planned and executed trips.

In some embodiments, the method further includes using artificial intelligence for real-time identification of trip execution status to generate vehicle operational adjustments in real time.

In some embodiments, the method further includes generating a plan to navigate one or more of the electric vehicles through a charging depot based on the optimal Key Performance Indicator. In some embodiments, the plan is transmitted to a driver of a vehicle using an user interface. In other embodiments, in which the vehicle is autonomous, the plan is transmitted as instructions to the vehicle to automatically navigate the vehicle.

In some embodiments, the DRL model is trained on at least historical vehicle data, General Transit Feed Specification (GTFS) Data, or both.

In a third aspect, a method of efficiently utilizing electric vehicles in a transit fleet includes collecting sets of electrical vehicle, electrical charger data, or both for generating performance models for electric vehicles in a fleet of electric vehicles, electrical vehicle chargers, or both; converting, by a data convert, the sets of electrical vehicle data, the electrical charger data, or both, into standardized data for use in behavior models; generating or updating, from the standardized data, the performance models; using the performance models to predict vehicle performance, electrical charger performance, or both; storing the predicted vehicle performance, predicted electrical charge performance in a prediction store; determining a key performance index (KPI) for the utilizing the electric fleet; and generating work schedules for the electric vehicles along their respective routes based on contexts, charging schedules, or both, to obtain a KPI within a predetermined range. In some embodiments, the sets of electrical vehicle data are collected, at least in part, by onboard electronics on the vehicles, and transmitted by the onboard electronics to a data pull module. In some embodiments, the collecting and transmitting are both performed in real time. In some embodiments, the onboard electronics includes GPS, one or more processors, computer-readable media for storing computer-executable instructions that when executed by the one or more processors perform required functionalities, to name only a few examples.

In some embodiments, at least some of the electric vehicles are autonomous vehicles, and the method further includes translating the charging schedules into instructions for navigating the autonomous vehicles within a charging station; and transmitting the instructions to the autonomous vehicles.

In some embodiments, the method further includes receiving traffic data, weather data, maps data, or any combination thereof, for generating the performance models. In some embodiments, the contexts include weather along a route, traffic, maps, and state of charge of a vehicle.

In some embodiments, converting includes determining planned landmarks from planned data; pairing time and location planned data with real-time data; determining landmarks in real time and adjusting the planned data to correspond to the real-time data; and identifying features between landmarks to correlate real-time data with planned data. In some embodiments, the method further includes using the features, time, and location data to update the models.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 is a Work and Charging Schedule for optimizing one or more Key Performance Indicators (KPIs) for a fleet of Zero Emissions Vehicles (buses) in accordance with some embodiments.

FIG. 2 is a block diagram of an architecture for automated ZEV Fleet operation in accordance with some embodiments.

FIG. 3 is a block diagram of a system for automated ZEV Fleet operation in accordance with some embodiments.

FIG. 4 illustrates a depot including charging lines, buses charging at charging stations, queues to enter the charging lines in accordance with some embodiments.

FIGS. 5 and 6 are block diagrams of systems for automated ZEV Fleet operation in accordance with some embodiments.

FIG. 7 shows the steps of a method for optimizing a KPI for a ZEV Fleet in accordance with some embodiments.

FIG. 8 shows the steps of a method of aligning real and predicted data to generate more accurate behavior models in accordance with some embodiments.

FIG. 9 is a block diagram of a Replanning Architecture for automated ZEV Fleet operation in accordance with some embodiments.

FIG. 10 shows a block diagram of a Parking and Charging Management Module and a portion of a Depot, in accordance with some embodiments.

FIG. 11 illustrates a ZEV maneuvering in a tightly constrained depot in accordance with some embodiments.

FIG. 12 is a block diagram of an exemplary module/sub-module/hardware component in accordance with some embodiments.

### DETAILED DESCRIPTION OF THE INVENTION

In accordance with some embodiments, at least some of the limitations of the prior art are addressed by using a hierarchical approach to increasing BEB utilization in transit fleets using Learning, Predictions, Optimization, and Automation.

In accordance with the principles of the disclosure, ZEVs in a fleet are scheduled to perform certain work, to charge, or both, in a way to increase a Key Performance Indicator (KPI) for a fleet of electric vehicles. For example, the KPI to be optimized can be total cost of ownership of the fleet, the utilization of the fleet, or the operating expense of the fleet, to name only a few examples. In some embodiments, a KPI is maximized (or is within a certain acceptable range) by assigning ZEVs to blocks in a way that utilizes fleet battery consumption and recharges the fleet batteries more efficiently, such as by charging batteries during off peak hours, charging groups of batteries in combinations and at times to reduce overall cost, etc. In some embodiments, this result can be achieved by following a schedule that reflects assigning work to buses and determining charging times, durations, and locations.

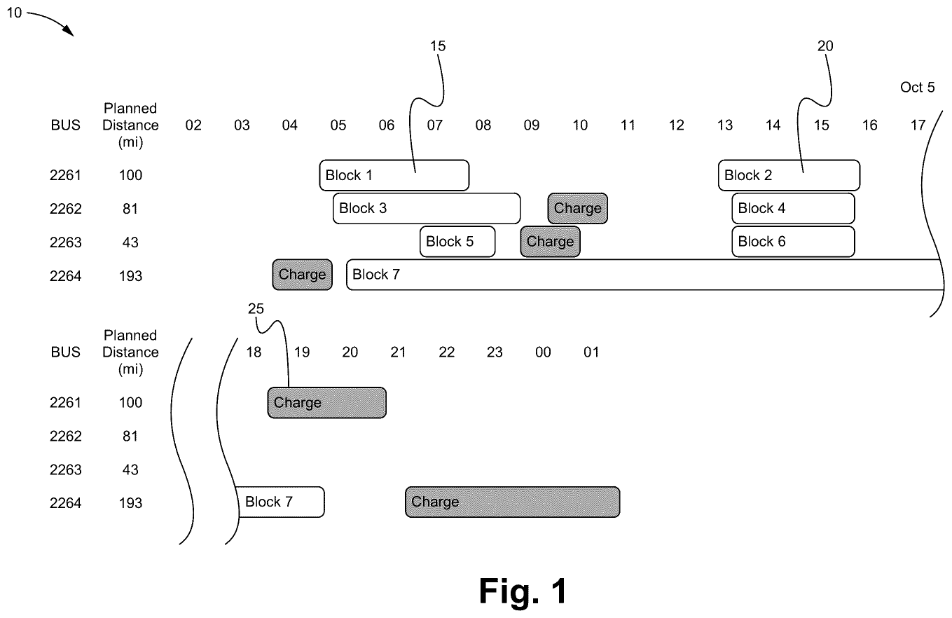

FIG. 1 is a Schedule 10 used to illustrate increasing a KPI for the utilization of a ZEV Fleet. As used herein, in some embodiments, “optimize” means, as one example, achieving an optimal value for a KPI or a value within a predetermined acceptable range. As shown in Schedule 10, the rows correspond to specific ZEVs (here, buses) and the columns correspond to particular times of day. In Schedule 10, white blocks and their lengths indicate the durations of a piece of work for a particular bus under certain conditions, such as the time of day, traffic, weather, etc., and the length of the solid blocks refer to charging times. In other embodiments, the solid blocks and their lengths indicate the amount of battery capacity required by a particular bus to perform a block of work under certain conditions. In still other embodiments, the length of a white block directly correlates to the amount of battery capacity required by a particular bus to perform a block of work under certain conditions. In this example, the energy that a particular ZEV requires to perform a piece of work is first determined. Referring to Schedule 1, Bus 2261 requires 42% of its battery charge to perform Work 15 (indicated by the length of the block 15) and 38% of its battery to perform the Work 20. Block 25 indicates that it takes 2 hours and 45 minutes to charge Bus 2261's battery. These charging times are used to schedule timing for charging the buses in the fleet, such as by staggering the charging, bundling the charging of the buses so that different combinations of buses are charged as different times, to name only a few examples.

In some embodiments, a second feature of systems is to schedule the work in a way to satisfy constraints, such as the ability of a bus to perform the work (e.g., an older bus with an older battery may not have the range to complete the work), a minimum State of Charge (SOC) at a particular point in a route, whether chargers are available along the route, a charge time for a bus, given that different buses charge at different rates (older or larger buses may take longer to charge), and electric tariffs, to name only a few examples. As explained in more detail below, charging costs vary by time. For example, the cost of charging Bus 2261 between 5 am and 7 am may be cheaper than charging it between 3 pm and 8 pm. During peak hours it may be less costly to charge only 3 buses, while at off-peak hours 8 buses can be charged at once for a similar cost. In this example, the KPI corresponds to operation expenses.

As explained in more detail below, systems in accordance with some embodiments include a Forecast Module for building ZEV and charger behavior/performance models, which are fed to an Optimization Engine. As one example, the Optimization Engine generates data corresponding to Schedule 10, which allows a system to utilize buses in the ZEV Fleet (e.g. assign buses to routes, schedule buses for charging, assign buses to charging lanes in a charging depot, assign buses to charging station, etc.) optimally.

These models and assignments can be generated every day or triggered by particular events (e.g., at a specific time of day, at predetermined time intervals, on the occurrence of an accident along a route resulting in unexpected delays, on the occurrence of a flat tire, on the bus returning before finishing a route because the driver fell sick, etc.). When the system does not work as planned, the result is referred to as “low block adherence” or “low plan adherence.” In some embodiments, based on the occurrence of these events, the assignments are replanned to optimize the KPI based on the changed circumstances.

Systems in accordance with some embodiments generate behavior models to predict ZEV and charger performance. Using these predictions, work assignment and charging strategies are developed to optimize KPIs. In some embodiments, these models are generated using physics-based algorithms, neural networks, other suitable models, and solving mathematical optimization problems. As explained n more detail below, in some embodiments the optimization problems depend on SOC dynamics, vehicle initial and final state constraints, vehicle safety constraints, and bus-to-block constraints. After reading this disclosure, those skilled in the at will recognize other optimization methods in accordance with the principles of the disclosure.

A system in accordance with some embodiments includes three components, a ZEV Digital Twin Module, a Predictive Block Assignment Module, and a Depot Parking and Queue Charging Management Module, each described in more detail below.

### I. System Components

### A. ZEV Digital Twin Module

The ZEV Digital Twin Module accurately predicts BEB charge consumption on a per vehicle, per driver, and per route basis, and accurately predicts the time to charge a ZEV's battery to any level. Here, learning is employed to build high accuracy prediction models of ZEV energy consumption and charging time; such models are a fundamental building block of energy-aware algorithms. A digital twin refers to a component for digitally replicating a physical object, including its features, functioning, and behaviors, in a virtual environment, such as used for modeling.

### B. Predictive Block Assignment Module

The learned ZEV models are used to generate accurate per-trip predictions of charge consumption and battery time-to-charge. These ZEV models are then used to maximize BEB fleet utilization through predictive optimal block assignment using the Predictive Block Assignment Module. This Module computes the optimal BEB daily assignment and charge management strategy. After reading this disclosure, those skilled in the art will recognize that variations of this problem have been formulated, e.g., to minimize the overall energy consumption of the fleet, assuming the availability of battery swapping or fast charging, decoupling the vehicle assignment and charge management problems. Those skilled in the art will also recognize that, in accordance with some embodiments, different problems can also be solved, such as the optimization of the fleet mix, optimization of the charging infrastructure, schedule optimization for electric buses, vehicle routing problems with energy constraints and/or mixed fleets.

### C. Depot Parking and Queue Charging Management Module

In accordance with some embodiments, a Depot Parking and Queue Charging Management Module is used to efficiently park vehicles based on their charging demands. This Module pre-computes trajectories for BEBs to maneuver inside a depot efficiently, get to a charging dispenser in time, and charge according to the charge strategy assigned by the high-level modules. If autonomous driving and autonomous charging are not available, the output of this Module can be used as a reference for a human driver and operator. (In some embodiments, the ZEV Digital Twin Module and the Predictive Block Assignment Module do not require any form of automation for the BEBs.)

Advantageously, some embodiments provide massive reductions of GHG emissions, providing cleaner air quality and less noise pollution to communities, in particular to low-income communities that rely more on transit services for their transportation need.

Below, several sections describe features in accordance with some embodiments: Section II provides some background on ZEV transit fleets and on electric mobility on demand services. Section III describes system architectures. Section IV describes matching predicted and actual (e.g., real-time) data to make more accurate predictions. Section V describes automated learning of digital twins. Section VI describes optimal block assignments and charging strategies. Section VII describes a Replanning architecture for adapting models on the fly to more accurately predict performance in light of changed conditions. And Section VIII describes Depot Parking and charging.

### II. ZEV Fleets in Fixed Schedule Transit

In general, transit agencies aim at avoiding BEB stranding due to lack of charge (resulting in the interruption of the current trip and the need to send a replacement bus), reducing the cost of service (due to nonlinear increases of electricity cost associated with high power and peak hour demand), and maximizing BEB usage and longevity. Below, some of the transit operations for which the introduction of BEBs is most challenging are described.

### A. Scheduling, Planning, and Assignment

Vehicle assignment refers to the problem of assigning blocks to buses on a daily basis, depending on their availability (for instance, buses may need maintenance and are unavailable for the day). In traditional bus operations, buses of the same type (e.g. occupancy and geometry) are fully interchangeable between blocks, limited only by the accessibility of each bus in the depot. The introduction of BEBs has created the need to limit their assignment to certain blocks, particularly due to their limited driving range and their dependence on battery capacity, current SOC level, and the varying energy demand of each BEB on different blocks. Normally, the depot operators present the vehicle locations and suggested block assignments to the drivers, up to 1-2 hours before the start of a block (pull-out time). Currently it is not possible to precisely predict the ability of a BEB to complete a block, or its SOC when it returns to the depot, or how long it will take to charge it to a certain SOC such that it can run another block later in the day. Depot operators currently make such predictions based on simplistic models such as miles-per-gallon equivalent (MPGe) and miles-per-charge, calculated by observing the change in the SOC, and on specific notes on which blocks can or should be assigned to BEBs. These models only capture the traveled distance and neglect other critical factors for energy consumption (such as traffic, weather, topography, driver behavior, and passenger occupancy); the resulting predictions have high uncertainty, which in turn leads to over-conservatism and poor utilization of BEBs. To overcome these drawbacks, some embodiments are directed to automated block assignments.

### III. System Architecture

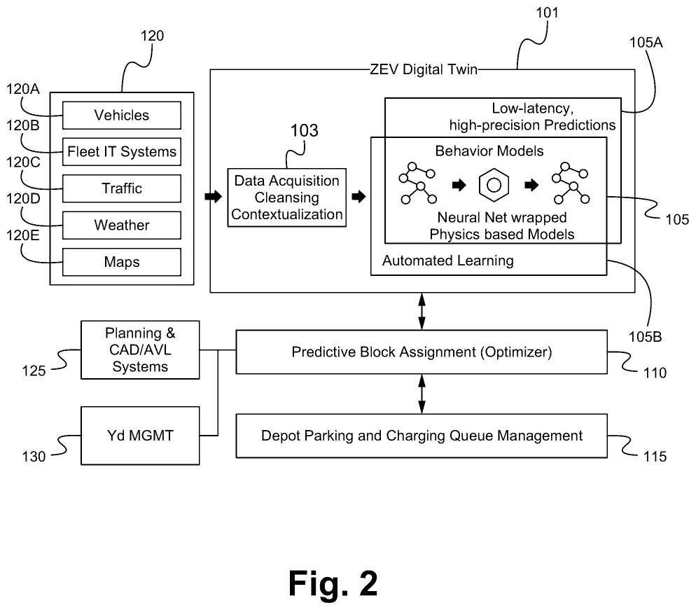

FIG. 2 is a high-level block diagram of a system 100 for the automated ZEV Fleet operation in accordance with some embodiments. The system 100 includes a ZEV Fleet Digital Twin Platform 101, an Optimal Block Assignment and Optimal Charging Strategy Module 110 (to simplify the discussion below (also referred to as “Optimal Block Assignment Module”), a Depot Parking and Queue Charging Management Module 115, an Input Module 120, a Planning & Computer-Aided Design/Automatic Vehicle Locator System 125, and a Yard Management Module 130. The Fleet Digital Twin Platform 101 includes a Data Acquisition Cleansing Contextualization Module 103 coupled to a Behavior Models Module 105 that includes a Low-Latency, High-Precision Predictions component 105A for generating behavior models using neural network, physics-based models, other suitable models generating algorithms, or any combination thereof, and an Automated Learning component 105B that generates/updates the models based on real-time, historical, or other data.

The Input Module 120 includes a Vehicles sub-module 120A, a Fleet IT Systems sub-module 120B, a Traffic sub-module 120C, a Weather sub-module 120D, and a Maps sub-module 120E, which receive data corresponding to, respectively, ZEVs in the fleet, Fleet IT, Traffic along routes, weather along the route, and maps. The Input Module 120 is coupled to the Data Acquisition Cleansing Contextualization Module 103, which in turn is coupled to the Behavior Models Module 101. The Behavior Models Module 101 is coupled to the Optimal Blocks Assignment Module 110, which in turn is coupled to Depot Parking and Charging Management Module 115. In some embodiments, arrows indicate the direction of the flow of data, where data refers to any information including status, control signals, instructions, etc.).

In operation, the Input Module 120 transmits to the Data Acquisition Cleansing Contextualization Module 103 information such as vehicle data from the Vehicles sub-module 120A, Fleet IT data (e.g., a particular bus is non-operational such as having a flat tire) from the Fleet IT Systems sub-module 120B, traffic information (e.g., a street on a route is blocked due to an accident) from the Traffic sub-module 120C, weather data from the Weather sub-module 120D, and maps data (e.g., to provide alternate routes based on the blocked or congested routes, etc.) from the Maps sub-module 120E. In some embodiments, some or all of the sub-modules 120A-E are third-party applications, such as provided by weather.com, google maps, etc.

The Data Acquisition Cleansing Contextualization Module 103 receives this input data, translates it into a format suitable for processing on the system, contextualizes it, and transmits it to the Behavior Models Module 101. The Behavior Models Module 101 generates behavior models, such as vehicle performance models, depot electric vehicle charger models, etc., to predict vehicle and charging performance. The ZEV Fleet Digital Twin Platform 100 forecasts, for example, the amount of energy a particular ZEV on a particular block requires to perform a particular work. As explained below, in some embodiments, this prediction/forecast is performed once at day, to account to account for daily changes in traffic, bus degradation, weather, etc. As shown in FIG. 2, in some embodiments these models are generated using automated learning. Generating and Updating Behavior and Performance Models is disclosed in U.S. patent application Ser. No. 17/525,318, titled “Systems for and Methods of Real-Time Contextual Intelligence for Context-Aware Smart E-Mobility,” filed Nov. 12, 2021 (the '318 application), which is hereby incorporated by reference in its entirety.

The generated models are transmitted from the Behavior Models Module 101 to the Optimal/Predictive Block Assignment (Optimizer) Module 110, which determines optimal block assignment and depot charging strategies and transits them to the Depot Parking and Charging Management Module 115. The Optimizer Module 110 determines how best to assign work considering, for example, State of Charge dynamics, vehicle initial and final constraints, vehicle safety constraints, depot charging constraints, and vehicle-to-route constraints. As one example, the Optimizer Module 110 outputs data corresponding to Schedule 1.

As explained in more detail below, in some embodiments the Depot Parking and Charging Management Module 115 accounts for constraints in real time.

As shown by the bidirectional arrows in FIG. 2, a feedback loop is maintained between the Modules 105 and 110 and between the Modules 110 and 115. For example, if a given BEB cannot charge to the desired level in the given time, a lower-level module will communicate with the Optimizer Module 110 to request a new assignment based on the current unplanned state.

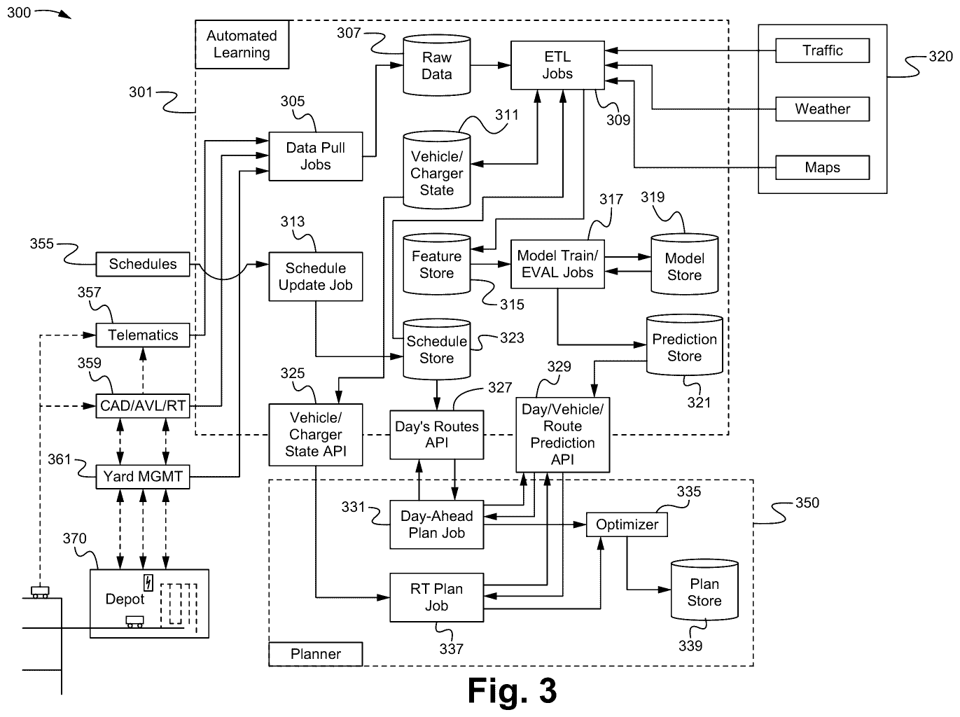

FIG. 3 is a block diagram of a system/architecture 300 for automated ZEV Fleet operations in accordance with some embodiments, showing some of the elements of FIG. 2 in more detail. The system 300 includes an Automated Learning Module 301 coupled to a Planning/Optimizer Module 350. The Automated Learning Module 350 includes a Pull Data Jobs Module 305, a Raw Data Module 307, an Extract/Transform/Load (ETL) Module 309, a Scheduler Update Job Module 313, a Vehicle Charger State Module 311, a Feature Store (e.g., Database) Module 315, a Schedule Store 323, a Model Train/Evaluation Jobs Module 317, a Model Store 319, a Prediction Store 321, a Vehicle/Charger State API 325, a Daily Routes API 327, and a Day/Vehicle/Route Prediction API 329.

The Planner/Optimizer Module 350 includes a Day-Ahead Plan Job Module 331, a Real-Time Plan Job Module 337, an Optimizer 335, and a Plan Store Database 339. The system 300 also includes an Input Module 320 for transmitting third-party Traffic, Weather, and Maps data, such as supplied by the components 120C, 120D, and 120E, respectively, from Input Module 120 of FIG. 1. The system 300 also includes a Schedules Module 355 coupled to the Schedule Update Jobs Module 313, a Telematics Module 357, a CAD/AVL Route Module 359, and a Yard Management Module 361, all coupled to the Data Pull Jobs Module 305. A depot including a Depot Module 370 is coupled to the Yard Management Module 361, the CAD/AVL/Route Module 359, and the Telematics Module 355.

The Data Pull Jobs Module 305 is coupled to the Telematics Module 357, the CAD/AVL/Route Module 359, the Yard Management Module 361, and the Raw Data Module 307, which in turn is coupled to the ETL Jobs Module 309. The ETL Jobs Module 309 is coupled to and receives data from the Input Module 320. The ETL Jobs Module 309 is coupled to the Vehicle Charger State Module 311, the Feature Store Module 315, and the Input Module 320, which has functionality similar to the Input Module 120 of FIG. 1. The Feature Store 315 is coupled to the Model Training/Evaluation Jobs Module 317, which in turn is coupled to the Model Store 319 and also the Prediction Store 321. The Prediction Store 321 is coupled to the Day/Vehicle/Route Prediction API 329. The Schedule Update Jobs Module 313 is coupled to the Schedules Module 355 and the Schedule Store 323. The Schedule Store 323 is also coupled to the ETL Jobs Module 309 and the Day's Routes API 327.

The Vehicle Charger State API 325 is coupled to the Vehicle Charger State Module 311 and the Real-Time Plan Job Module 337. The Day's Routes API 327 is coupled to the Day-Ahead Plan Job Module 331, and the Day/Vehicle/Route Prediction API is coupled to both the Day-Ahead Plan Job Module 331 and the Real-Time Plan Module 337. The Optimizer 335 is coupled the Day-Ahead Plan Job Module 331 and the Real-Time Plan Job Module 337. The Optimizer 335 is coupled to the Plan Store 339.

In operation, the Data Pull Jobs Module 305 pulls input data from a Telematics Module 357, the CAD/Available/Route Module 359, and a Yard Management Module 361, and transmits the data to the Raw Data Database 307. As some examples the Telematics Module 357 generates receives, stores, or processes for transmission vehicle and charger information collected or generated by vehicle onboard diagnostics, vehicle GPS technology, other onboard computer systems, or similar means, or any combination of these; the CAD/AVL/Route Module 359 generates, receives, stores, or processes passenger count for vehicles based on time of day, driver input/output times, vehicle availability, etc. The Yard Management Module 361 generates, receives, stores, or processes information such as which charging lanes in the Depot 370 are occupied, which lanes are “out,” which vehicles are queued in a particular lane waiting for a particular charger, which vehicles are queued by may only be charged at specific chargers because they have specific charging requirements that can be satisfied only by the particular chargers. The Data Raw Jobs Module 307 transmits the data to the ETL Jobs Module 309, which also receives traffic, weather, and maps (e.g., third-party) data input from the Input Module 320. The ETL Jobs Module 309, extracts the data, transforms them into a format usable by the system 300, loads the data, and transmits the data (now in the transformed state) to the Vehicle Charger State Module 311 and the Feature Store Module 315.

The Feature Store Module 315 transforms data, as necessary, into a format suitable for use by the models (discussed below), that is, in a format used by the models both for training the models evaluating their output. The Feature Store Module 315 transmits the transformed data to the Model Training and Evaluation Jobs Module 317, which generates and evaluates the models, and transmits the models to and retrieves models from the Model Store 319, and also transmits the transformed data to the Prediction Store 321.

The Schedules Module 355 transmits vehicle schedules to the Schedule Update Jobs Module 313, which in turn stores the schedules in the Schedule Store 323.

The Optimizer 335 receives data related to next-day and later jobs from the Day Ahead Plan Job Module 331 and routes plans from the Real-Time Plan Job Module 337, optimizes the jobs, and stores them in the Plan Store 339. The Day Ahead Plan Job Module 331 is coupled to the Day's Routes API 327, which can be triggered manually to execute the Day-Ahead Plan Job Module 331, which then transmits the generated data to the Optimizer 325 for optimization, and provides feedback to the Day's Routes API 327, such as to display the routes data to a user. The Real-Time Plan Module 337 is able to receive similar triggers from the Vehicle/Charger State API 325 and the Day/Vehicle/Route Prediction Module 329, provide feedback to the Day/Vehicle/Route Prediction Module 329, such as to display the information to a user, and to route corresponding data to the Optimizer 335, which stores the optimized data to the Plan Store 339. The Vehicle Charger State API 325 transmits vehicle charger state data from the Vehicle Charger State Module 311 to the Real-Time Plan Job Module 337, and can be invoked manually by a user who wants to view charger states, or automatically by the system, such as on the occurrence of an event, the elapse of a predetermined time interval, or at predetermined times, to name only a few examples.

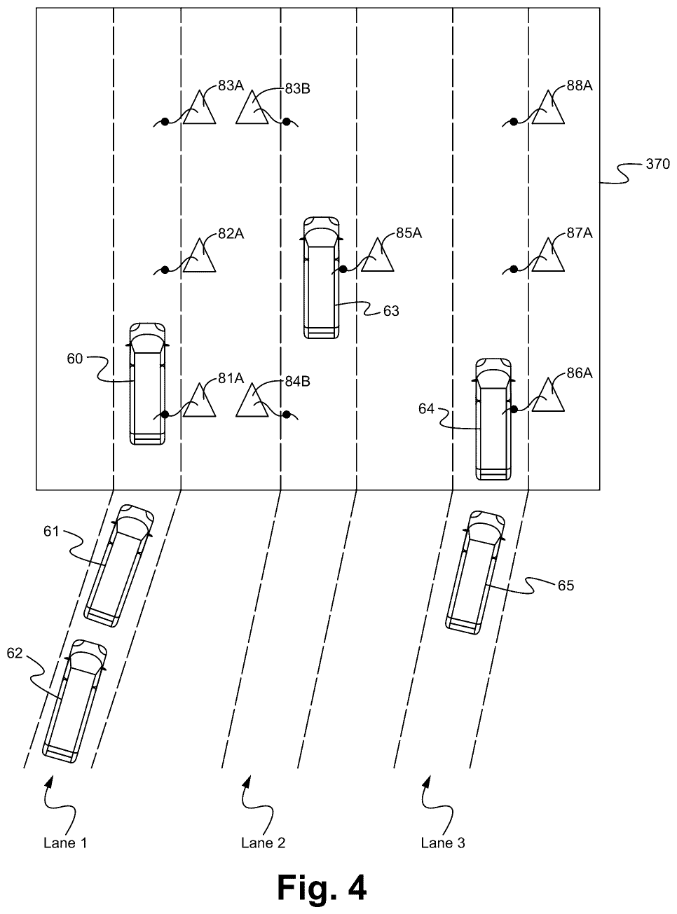

FIG. 4 shows the Depot 370 in accordance with some embodiments. The Depot 370 includes ZEVs 60-64, queued in lanes 1-3 or charging at charging stations (e.g., 81A).

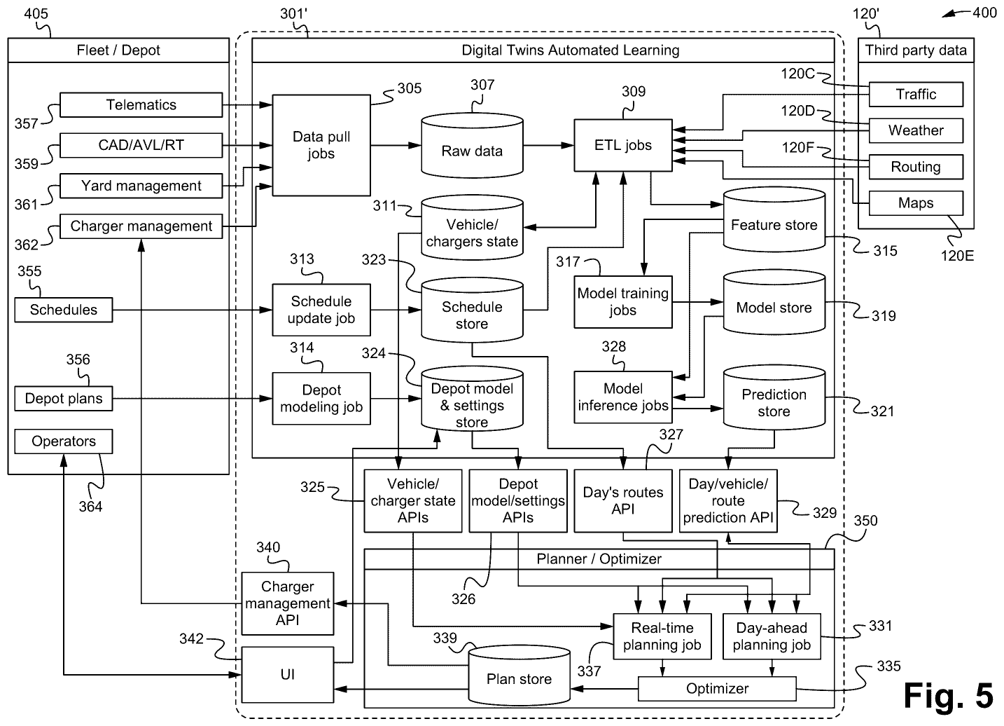

FIG. 5 is a block diagram of a system/architecture 400 for automated ZEV Fleet operations in accordance with some embodiments. Many of the elements in the system 400 are similar to those in the system 300 and will not be described in detail here. As shown in FIG. 4, in the system 400, a Fleet/Depot Module 405 also includes a Charger Management Module 362, a Depot Plans Module 356, and an Operators Module 364. The Digital Twins Automated Learning Module 301′ includes a Depot Modeling Job Module 314, a Depot Model and Settings Store Module 324, a Model Inference Jobs Module 328, and a Depot Models/Setting API 326, a Charger Management API 340, and a User Interface (UI) 342.

The Charger Management Module 362 is coupled to the Data Pull Jobs Module 305 and the Charger Management API 340, which in turn is coupled to the Plan Store 340. The Operator Module 364 is coupled to the UI 342, which in turn is coupled to the Data Depot Model & Settings Store 324 and the Plan Store 339. The Depot Modeling Jobs Module is coupled to the Depot Plans Module 356 and the Depot Model and Settings Store 324. The Depot Model/Settings API 326 is coupled to the Depot Model and Settings Store 324, the Real-Time Planning Jobs Module 337, and the Day-Ahead Planning Jobs Module 331. The Model Inference Jobs Module 328 is coupled to the Feature Store 315, the Model Store 319, and the Prediction Store 321.

In some embodiments, the Charger Management Module 362 not only stores charger state data but can also be used to control chargers. For example the Plan Store 339 can contain data indicating that a particular charger should be charging a predetermined amount at a specific time of day and a charging vehicle should have a corresponding charge. If this does not occur, the Charger Management Module 362 control the charger to increase its charging rate or flags the charger as inoperative, requiring that the vehicle be moved to another charger.

FIG. 6 is a block diagram of a system 500 for automated ZEV Fleet operation, in accordance with some embodiments. The system 500 includes many of the same or similar elements as the system 100. The system Depot Parking and Charging Queue Management Module 115 is coupled to both the Charge Management System 262 and an driving a 363. As one example, the system uses an L4 stack, which provides high driving automation. In other embodiments, the system uses an L5 stack, which provides for full driving automation. In still other embodiments, the system uses an L0 stack, with no driving automation, but provides a user interface (e.g., UI 432, FIG. 5) to display driving directions (e.g., routes through the depot) and recommendations (e.g., estimated charging times at candidate charging stations) to a driver of a vehicle. In some embodiments, the system will provide a current state of the depot, including which vehicles are charging at particular charging station, the number of vehicles blocking access to a particular charging station and an estimated time that the charging station will become available, the charging stations (available and unavailable) capable of charging a battery on a particular bus, a particular route through a depot (take lane 3, take a left on the access lane, take a right on lane 2, to bypass currently charging vehicles), to name only a few examples. It will be appreciated that other levels of driving automation are also contemplated in accordance with some embodiments. As shown in more detail in FIG. 5, the Depot Parking and Charging Queue Management Module 115 determines spot allocation and depot path planning.

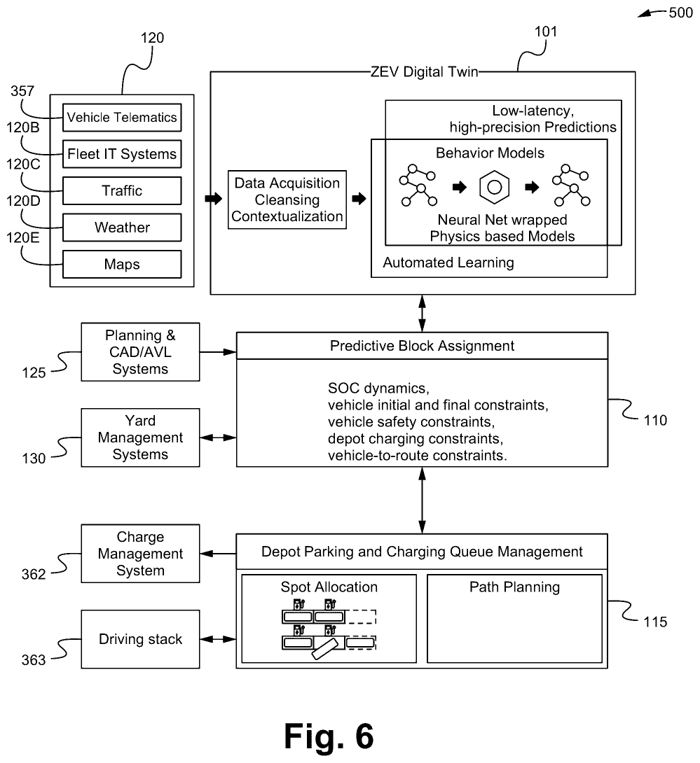

FIG. 7 shows the steps of a method 700 performed by a system for increasing the KPI for a fleet of ZEVs in accordance with embodiments of the disclosure. Using the system 100 as an example to illustrate the method, first, in a step 701, a KPI to optimize is selected, for example, total cost of ownership, fleet utilization, or operating expenses, to name a few examples. Next, in a step 705, work for the entire fleet is divided into separate trips, which in turn are divided into separate blocks. Next, in a step 710, for each of vehicle in a fleet, the amount of energy required for each particular vehicle to perform the work in its block is determined. Next, in a step 715, behavior/performance models for the vehicles and chargers at a depot or off-site charging station are generated in the ZEV Digital Twin 101. In some embodiments, for large fleets, the time and resources to generate a behavior model for each vehicle is prohibitive. Thus, in some embodiments, behavior models are generated only for each type of vehicle.

Next, in a step 720, in the Optimizer 110, the blocks of work are assigned to the vehicles and charging strategies are determined to optimize the KPI. Finally, in a step 625, in the Depot Parking and Charging Queue Management Module 115, control signals or instructions are generated for the vehicles to be parked, navigated through, and charged within the depot. When the ZEVs are automated vehicles, the control signals or instructions may be executed to automatically control the automated ZEVs. The steps 620 and 625 are performed to optimize the KPI to keep the KPI within an acceptable range.

It will be appreciated that the steps 700 are merely illustrative. As with all the methods described herein, in other embodiments, some steps are deleted, some steps are added, the steps are performed in different orders, or any combination thereof.

### IV. Matching Planned and Actual Data

In some embodiments, planned data are mapped to actual data to generate more accurate models. Predicted time, locations, features, etc., are correlated/matched to correspond with actual time, locations, features, etc., to ensure more accurate predictions. In some embodiments, the progression along a time, location, etc., is measured along a respective “axis,” used for taking measurements and generating models. Put another way, data (e.g., features data) for a particular vehicle, location, and time are mapped in a multi-dimensional, non-linear way (“warped”) so that all the data are located on the same stream of location and time.

As an illustration of some embodiments, traffic is a measurement along a route that varies with time, weather, speed of the vehicle, all on different axes of measurement. Some data are gathered on a first axis (e.g., an abstract element for storing, comparing, or organizing data points) that is uniform with time, other data, on a second axis that is uniform with speed, still other data on a third axis that is uniform with geography, etc., where no axis is uniform to the others. The axes must be matched or mapped so that corresponding data coincide with each other and at the checkpoints for the work to be done.

It will be appreciated that, typically, raw data does not line up perfectly with a schedule. The data must be aligned with a schedule to perform model learning. In some embodiments, the alignment refers to “standardization” for the Feature Store 315.

In some embodiments, mapping correlates work to physical dimensions and physical predictions, even if vehicles do not move uniformly along an axis. For example, a plan may be generated for a trip to school. The plan is based on a predicted time (e.g., start time), location, geography. The trip may be delayed and, due to different traffic, the route may change. The predicted data must be mapped to the actual data, so that the model can be accurately determined. Referring to FIG. 3, in some embodiments, the ETL Jobs Module 309 takes the data from the Raw Data Module 307 and data from the Input Module 320 and “warps” the data for storage in the Feature Store 315. As one example, the data are “normalized/standardized” with respect to a time axis warped by landmarks, not just to individual axes of time, location, etc.

For example, plans can be executed earlier or later, faster or slower than predicted. The data from the predictions must be mapped into the plans as actually executed to perform valid learning; otherwise, the given predictions based on earlier or later work will not be accurate. Because pieces of work are not aligned, non-linear contextual data must be mapped to the actual work.

In accordance with some embodiments, raw data is collected for a plan, and “landmarks” (axes of location and time) are identified. A set of locations and times as planned are determined, used to align data points as planned. In real-time, locations of landmarks are determined. The actual and predicted locations may align at different points (e.g., predicted time to reach location is 10:15 am, but actual time is 10:30 am). For each segment of work (e.g., block), the features are determined. These features are then transferred from the Feature Store 315 to the Model/Training EVAL Jobs Module 317. In some embodiments, features include SOC, time for a block/route/trip traversal, average temperature along a block/route/trip, average traffic density/patterns, to name only a few examples.

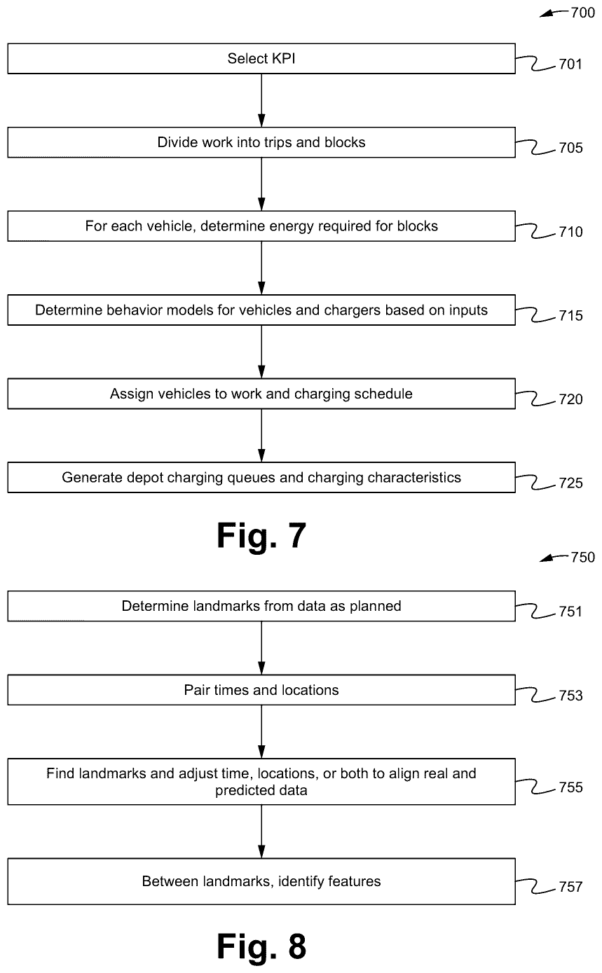

FIG. 8 shows the steps 750 of a method of determining standardized features in accordance with some embodiments. First, in a step 751, landmarks are taken from data for a planned work. Next, in a step 753, pairs of times and locations are determined. Next, in a step 755, landmarks are found in real time, and times, locations, or both are adjusted (e.g., “warping”). Next, in a step 757, between landmarks, features are identified and collected. The features are then stored in the Feature Store 315 (FIG. 5).

It will be appreciated that the steps 750 are merely illustrative. In some embodiments, additional steps are added or some are deleted, and the steps can be performed in different sequences, to name only a few examples.

In some embodiments, the steps 700, 750, or both are performed on the ZEV Digital Twins Platform 101, the Optimizer 100, the Depot Parking and Charging Queue Management Module 115, the Yard Management Module 130, the Automated Learning Module 301, the Planner/Optimizer Module 350, to name only a few examples. Further, the functionality can be distributed across multiple components. After reading this disclosure, those skilled in the art will recognize other ways of distributing functionality across multiple components. In some embodiments, the steps 700, 750, etc., are executed by a processor executing computer-executable instructions on the platform/module/sub-module/hardware component in the cloud. Those skilled in the art will recognize that performing the steps (e.g., receiving data, optimizing, generating schedules and AV instructions, otherwise processing and storing data, etc.) using computer hardware/software allows for the rapid execution of multiple steps, for multiple vehicles, in parallel (if necessary) for real-time, efficient processing.

### V. Automated Learning of Digital Twins for Transit ZEVS

In accordance with the principles of the disclosure, energy aware algorithms are dependent on Digital Twins that model the energy performance of ZEVs.

Obtaining high-precision predictive models of vehicle energy consumption is challenging as energy consumption is greatly affected by a long list of factors that depend on the specific vehicle, driver, and driving environment. These factors include speed profile, vehicle load, road gradient and curvature, ambient temperature, wind speed, state, and aging of the vehicle components.

Platforms in accordance with some embodiments deliver high-precision energy consumption prediction for EVs and are tailored for real-time optimization. The platforms leverage real-time data streams from vehicles' telematics, traffic, and weather forecasts, and deliver tailored route and charging recommendations. “Contextual prediction” refers to prediction obtained with automatically learned, highly accurate vehicle energy performance models from real-time vehicle sensor telemetry and other data streams including slope, traffic forecasts, driver behavior, and weather.

In some embodiments, the platform includes (A) physics-based vehicle performance models, which capture the energy consumption and travel time on a per-vehicle, per-driver, per-road-segment basis, and (B) a data-driven learning algorithm, which can estimate the parameters of the vehicle performance models in order to deliver high precision charge consumption estimation and charge depletion trajectories on routes for electrified vehicles. In some embodiments, the platform automatically learns from data over time and can also adjust to the degradation characteristics of the vehicle components, including the drivetrain, battery, and motor, to name only a few examples.

Accurate prediction of the trip charge consumption has been demonstrated to be greater than 90% in 87% of trips on 50,000 miles of road trials with a top OEM.

As an example, the Fleet Digital Twin Module 101 can generate the physics-based model below to describe the traction power demand of a two-wheel drive EV:

$${K}_{k} = M \text{?} a \text{?} + M \text{?} \text{?} ( sin \text{?} + C \text{?} cosa \text{?} ) + C \text{?} \text{?} + C \text{?} \text{?} \text{?} \qquad ( 1 )$$

$$\text{?} = \text{?} ( \text{?} ) ,$$

$$C \text{?} = C \text{?} ( s \text{?} \text{?} p \text{?} ) \text{?}$$

$$C \text{?} = C \text{?} ( \text{?} \text{?} \text{?} ϕ \text{?} ϕ \text{?} ) \text{?}$$

$$C \text{?} = \frac{{M}^{2} \text{?}}{aC \text{?} \text{?} ( \text{?} )} \text{?}$$

$$F \text{?} = F \text{?} + F \text{?} \text{?}$$

$$F \text{?} = ψ \text{?} ( F \text{?} \text{?} \text{?} \text{?} ) \text{?}$$

$$P \text{?} = \frac{F \text{?} \text{?}}{η \text{?} ( F \text{?} \text{?} θ \text{?} )} \text{?}$$

$$\text{?} \text{indicates text missing or illegible when filed}$$

where k is a time index, τ is a trip or route leg index, Fₘ and F_{b} are the forces from electric motor and friction, brakes (defined at the wheel), Pₜ is the electrical motor power used for traction, v, a and Φ are the vehicle speed, acceleration, and bearing, s is a curvilinear abscissa along the vehicle's path, α and ρ are the road gradient and curvature radius, M is the mass of the vehicle and its occupants, \tilde{M}_{τ} is M plus the rolling inertias, v_{ω} and Φ_{ω} is the wind speed and bearing, Cₛ is the wheel cornering stiffness. Cᵣ is a rolling resistance coefficient, defined as a nonlinear function of the road segment, vehicle speed, and tire pressure p. Cₐ is an aerodynamic coefficient, defined as a nonlinear function of the vehicle and the wind′ speed and bearing; σ takes discrete values corresponding to different configurations of the vehicle and its trailers and roof boxes. ψ_{b} is the function that allocates braking force to the hydraulic brakes, defined as a nonlinear function of speed and acceleration. ηₘ is the efficiency map of the electric motor, defined as a nonlinear function of the motor torque, speed, and temperature. All the above parameters and mappings are learned using state-of the-art machine contextual learning methods.

Similar models are derived for the auxiliaries, the battery, and the driver, and are here omitted for brevity. After reading this disclosure, those skilled in the art will recognize other means to generate these models or functionally equivalent models.

### VI. ZEV Optimal Block Assignment and Charging Strategy for Fixed Schedule Transit

This section presents the optimal block assignment and charging strategy for a mixed ZEV fleet, enabled by accurate predictions of block charge consumption and battery time to-charge. The objectives are to optimize:
$ the assignment of vehicles to blocks for maximum ZEV utilization, and
$ the charging schedule across a transit fleet, defining when and how much each BEB should be charged,
   while ensuring that ZEVs are safely operated within their minimum and maximum SOC, that physical constraints (such as the number and displacement of available electric chargers) are respected, bus-to-block constraints (certain blocks can only be completed by certain bus types, for instance, due to the bus size and the route geometry).

First, some notation and definitions are introduced to better explain the models. Let B be the set of available buses and each bus b∈B belongs to a certain bus type bₜ∈Bₜ capturing the manufacturer, model, trim, powertrain (internal combustion, hybrid electric, battery electric, fuel cell), capacity of energy storage (such as fuel tank capacity or battery capacity), rated driving range, maximum occupancy, weight, and payload. Each bus is also associated with a digital twin model bₘ∈Bₘ that can predict energy usage and charging time. The buses in B serve a set of blocks J. Each block j∈J includes both service trips, which serve the scheduled stops on a bus route, and non-service or deadheading trips, which connect the depot(s) and the start (end) of the first (last) trip, and the end and start of any consecutive pair of trips, in case they are not the same. Each block has an origin and destination (which in the common, single depot case is the same), and a start and end time. An assignment plan defines, on a given day, the blocks that each bus will serve.

In some embodiments, because the focus is on fleets that include some BEBs, a feasible assignment plan must ensure that BEBs are only assigned to blocks that can be completed without the BEB being stranded. Such feasibility depends on the SOC at the beginning and at the end of the day, on the minimum and maximum SOC allowed for the BEB, on the charge consumption incurred on the assigned blocks, and on the feasibility of charging the BEB up to the SOC required for the next block while it is at the depot. Similar to the assignment plan, the charging strategy defines, on a given day, the charging sessions for each BEB; each charging session is associated with a charging location in the depot, and a start and end time.

The fixed time optimization problem can now be formulated for the optimal block assignment and charging strategy for the BEBs in a fixed schedule transit fleet. The decision variables for the optimization problem include:
$ b_{i,j}, boolean variable indicating whether a bus i∈B is serving a block j∈J;
$ cᵢ(t), boolean variable indicating whether a bus i∈B is charging at time t.
   The optimization problem has the form:

$${minimize}_{{b}_{i , j} , {c}_{i} ( : )} - {\sum }_{i ∈ B} {\sum }_{j ∈ J} {b}_{i , j} {d}_{j} \qquad ( 2 )$$

$$subject to$$

$$SOC dynamics with {b}_{m} , vehicle initial and final state constraints , vehicle saftey constraints , depot charging constraints , bus - to - block constraints ,$$

where dⱼ, is the distance (utilization) of block j∈J, and the SOC dynamics represent, for each bus b∈B, the predictions by model bₘ of the energy used to service a block and added in a charging session.
b_{i,j} is binary (0, 1) variable: If b_{1,3}=1 (true), then bus 1 takes the third piece of work, that is, an assignment is made between bus 1 and a block 3. Each bᵢⱼs corresponds to the solid blocks in FIG. 1.
cᵢⱼ is binary, function of time, cᵢⱼ=1 if bus i is charging at time j.

SOC Dynamics refers to the depletion dynamics as well as the charging dynamics. SOC changes because the battery is doing work or is charging.

The vehicle initial and final state constraints enforce initial and final states, such as battery SOC and location, for each BEB. These constraints can be determined at night or early in the day, after a bus has charged (initial state) and after the final route (final state). In some embodiments, the constraint can be determined in real time. For replanning, discussed below. The vehicle safety constraints ensure that the buses operate within the safe SOC levels, e.g., a user-configurable range. The depot charging constraints model constraints imposed by the charging infrastructure in the depot; these can include the maximum number of parallel or serial charging, bus queue orders, the maximum number of buses being charged at a time, as well as (soft or hard) constraints dictated by utility rates and the need to limit peak power demand. In some embodiments, the depot charging model is a mathematical model indicting spots in a depot, a sequence of parking spots (lanes), locations of chargers, dispensers associated with each spot, etc. Finally, the bus-to-block constraints ensure that some blocks are only served by certain bus types bₜ.

### VII. Replanning Architecture

In some circumstances, the context for the ZEVs changes, resulting in models that do not adhere to the earlier generated models. Thus, to properly forecast vehicle and charger behavior, the models must be updated in real-time (e.g., within minutes rather than hours), such as when the ZEV is traveling along its scheduled route. To this end, the constraints in Equation 2 must be adjusted, the models must be updated to reflect these new constraints, and any assignments and charging scheduling must be replanned to optimize the KPI. In other words, the system “adapts” to the changed conditions, by, for example, dynamically adjusting the state of the vehicle, the state of the depots, the state of the work, or any combination thereof. This increases block adherence.

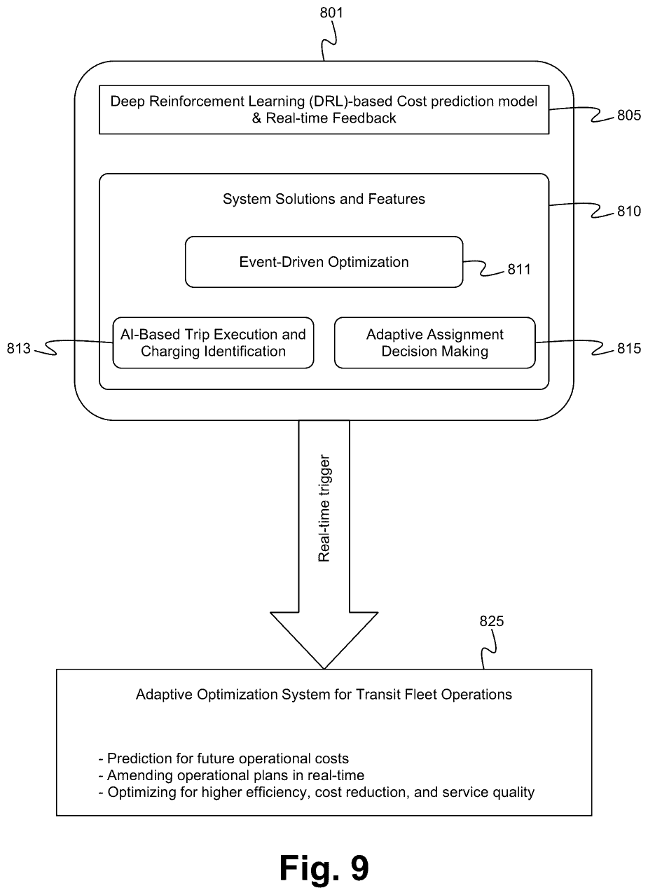

FIG. 9 is a block diagram of a Replanning Architecture 800 in accordance with some embodiments. The Replanning Architecture 800 monitors the EVB in real time, along its route, and, taking into account real-time context, updates the cost/decision models to make more informed and thus accurate decisions about vehicle charging and fleet operation.

The Replanning Architecture 800 includes a Deep Reinforcement Learning (DRL)-based Cost Prediction Model with Real-Time Feedback 805 and an Adaptive Optimization System for Transit Fleet Operations 825. The DRL-based Cost Prediction Model with Real-Time Feedback 805 includes an Event-Driven Optimization Module 811, an AI-Based Trip Execution and Charging Identification Module 813, and an Adaptive Assignment Decision Making Module 815. In operation, an EVB is monitored along its route. When the Architecture 700 determines that a plan is not being executed, such as by the actual cost function deviating from the predetermined cost function by at least a predetermined amount, a real-time trigger is activated. The real-time trigger causes the system to execute the Adaptive Optimization System for Transit Fleet Operations 825 to regenerate a prediction that is more accurately based on the current data, predict the future operational costs based on the new model, amend the operational plans (e.g., route) is real time, and optimize the plan for higher efficiency, reduced cost, service quality, or any combination of these, weighted based on importance, which can be configured in real time (on the fly) or at an earlier time.

Referring to FIGS. 1 and 9, the Architecture 800 can be incorporated within the Fleet Digital Twin Module 101 or distributed between the Fleet Digital Twin Module 101 and the Optimizer Module 110. In other embodiments, the Architecture 800 can be distributed among any number of components.

In some embodiments, the method 700 is adapted for replanning. As one example, the system monitors for events in or after any of the steps 715, 720, or 725, and, if any event is detected, the method loops back to the step 710 or the step 715. For example, the method may loop back to the step 710 if, based on vehicle malfunction, the vehicles requires more energy to perform work.

In some embodiments, the optimization in equation (2) is triggered under specific conditions, such as:
$ Event-Triggered Optimization: The optimization problem is re-solved whenever a specific event occurs, such as a vehicle (e.g., a bus) reaching a low State of Charge (SoC). This condition ensures that fleet operations can dynamically respond to critical battery levels, preventing service interruptions due to insufficient charge.
$ Periodic Optimization: The problem is also solved at regular intervals, defined by a parameter delta-time. This systematic approach allows for the re-evaluation of operational strategies at consistent times, ensuring the fleet adapts to changing conditions and demands even in the absence of specific triggering events.
$ Discrepancy-Triggered Optimization: Finally, the problem is solved when inconsistencies are identified between planned trips and those actually executed. This condition addresses the need for real-time adjustments to the fleet's operation plan, ensuring that discrepancies (such as delays, cancellations, or reroutings) are promptly accounted for and corrected in subsequent operational decisions.

In some embodiments, an advanced optimization system for transit fleet operations employs a Deep Reinforcement Learning (DRL)-based cost prediction model. This model dynamically predicts future dispatching costs by considering vehicle states, operational parameters, and environmental conditions, thereby enabling informed and adaptive assignment decisions for transit fleets.

This Learning-Based Cost Prediction Model analyze historical and real-time data, predicting future operational costs with high accuracy. These algorithms incorporate variables such as vehicle state of charge (SOC), traffic conditions, service demand, and environmental factors to refine cost predictions. They guide the dynamic assignment of vehicles to routes and schedules, optimizing for efficiency, cost reduction, and service quality.

In addition to being event-driver, some embodiments include one or more additional features:
1. AI-Based Trip Execution Identification: Utilizes AI to determine in real-time the status of trip execution, enhancing the system's ability to adapt to operational realities.
2. Adaptive Assignment Decision-Making: Leverages the cost prediction model to make informed decisions on vehicle assignments, route adjustments, and schedule adaptations.

### VIII. Depot Parking and Charging

This section presents the module to manage the motion of ZEVs inside the depot according to the charging schedule. The vehicles can be notified through dashboard messages or phone APPs, or autonomously controlled if equipped with a self-driving stack (e.g., level 4).

As will be described in more detail below, in some embodiments, the system knows the state of a yard/depot, including how charging queues are formed. For example, in accordance with some embodiments, the systems knows (1) where each vehicle in a depot is parked, (2) the state of the vehicles in the queues, (3) which vehicles can be assigned to a charging station, (4) how long each vehicle must be charged, or (5) when a vehicle may be available after it has finished charging (e.g., it may be blocked in its lane, for example, a second vehicle is blocking its exit from the depot, and the second vehicle has not yet finished), or any combination of these. In some embodiments, the system generates, updates, or otherwise uses a model of the depot, including modeling the layout of lanes, queues, locations of charging stations, capacities and charging times (based on particular vehicles charging), charger charging capabilities (e.g., some vehicles can only be charged by certain types of chargers and thus may queue only for those chargers), to name only a few examples. The system may thus send instructions (using a UI or automated instructions for autonomous vehicles) to navigate the vehicles to particular queues to charge at particular chargers.

### A. Off-Route or Depot Charging

Off-route or depot charging refers to charging the BEB battery outside of its service trips, typically at a depot equipped with charging infrastructure. BEBs may be charged both overnight (after their daily assignments have been completed) and during the day (between different blocks). In the current state of the art, vehicles are only assigned to blocks up to 1-2 hours before pull-out; thus, even if the energy required by each BEB on each possible block was predicted with high accuracy, the decision to charge a BEB would have to be made, in most cases, before the next block (i.e., the target SOC and time at the end of the charging session) is known. In other words, planning depot charging sessions is tightly coupled with the assignment of vehicles to blocks. For this reason, the current practice utilizes the depot chargers suboptimally; often this translates to charging BEBs as soon as they get back to the depot and until they reach a sufficiently high SOC. Typically, not only does the energy demand depend on the block, but the blocks to perform may be different every day (in the simplest case there may be a weekday schedule and a weekend schedule). Finally, a certain amount of “opportunistic” charging is generally desirable, as it potentially allows BEBs to be used as relief vehicles, and not just for their assigned blocks.

In this context, variable utility rates and charging infrastructure costs provide a set of incentives and constraints. It is desirable to maximize the amount of charging during offpeak hours when the cost per kWh is lower. For instance, vehicles plugged in at the end of a shift prior to the time of lower utility rates will cost more to charge than if their charging were delayed until the off-peak hours. Preferably, to optimize costs, the charging profile maximizes energy use during the off-peak time while completing the charge prior to the next pull-out time. It is also desirable to minimize the peak charging power used, as the utility rate also depends on the maximum power needed from the grid. Charging power is a nonlinear function of the vehicle SOC: it is normally highest in the middle SOC range (normally between 20% and 60%-80%) and decreases when approaching the SOC bounds. To smooth out charging power peaks while keeping the overall charging time limited, in some embodiments, charging for different BEBs is staggered, so that the number of BEBs simultaneously charging at maximum power is “minimal” (e.g., within an acceptable range).

Typically, it is more cost-effective to operate on a lower “charger to bus” ratio (i.e., not having a charger dedicated to each BEB). In this case, however, the depot cannot simultaneously charge all the BEBs in the fleet. This can limit the flexibility in pursuing the general objective of maximizing BEB utilization. In some embodiments, depot charging queues in the block assignment are modeled to obtain a feasible assignment.

### B. Parking and Charging Management

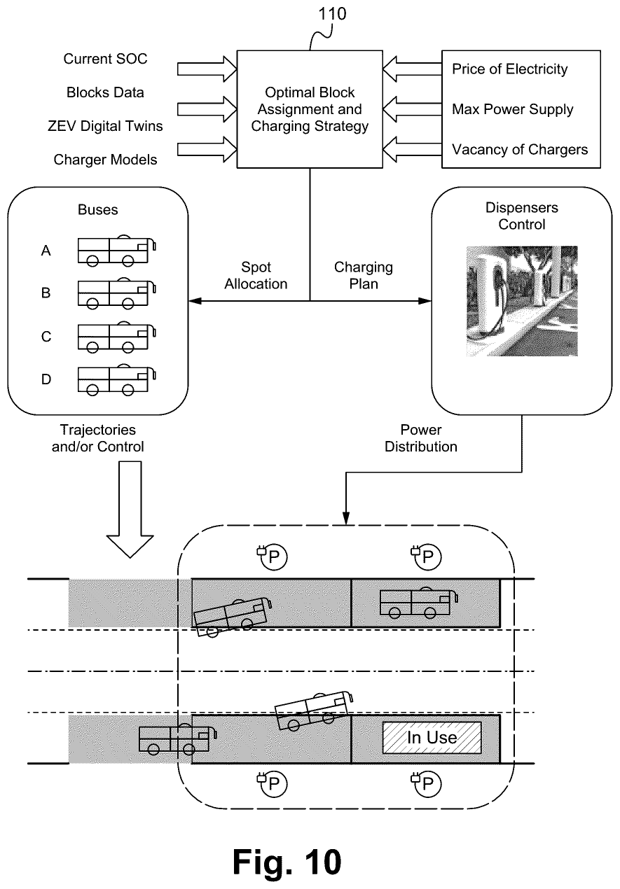

As illustrated in FIG. 10, when a fleet of ZEV enter the depot, they can report to the system the necessary parameters, such as their current state of charge (SOC), blocks data, ZEV digital twins, and charger models. By observing and predicting the parking and charging demand, a cloud server can solve the optimal block assignment and charging strategy and notify the vehicles of their assigned time and location of the parking spot, their planned charging schedule, and the path to reach the spots.

Referring to FIG. 10, on some embodiments, a ZEV can be either assigned immediately to spots with chargers (e.g., buses A, B, and C) or tentatively assigned to parking-only spots on a waitlist (e.g., vehicle D). For the latter case, the system can coordinate the interchange of vehicles on a charger. When one of the buses finishes charging (e.g., vehicle C), it can be asked to leave the charging spot as soon as possible to serve a block. When it leaves, the vehicle on a waitlist (e.g., vehicle D) can be notified to move in and use the now-open charger.

### C. Autonomous Control of Vehicles

If any of the ZEVs is autonomous with a selfdriving stack (e.g., level 4), it can self-drive along a designated trajectory to maneuver in and out of the charging spot. Given the initial state zₒ, target state z_{F}, and vehicle dynamics i=f(z, u) of an ZEV, the trajectory planning problem can be solved with the formulation:

$${min}_{z , u , T} J = {\int }_{t = 0}^{T} c ( z ( t ) , u ( t ) ) dt$$

$$s . t . \dot{z} ( t ) = f ( z ( t ) , u ( t ) ) , \qquad ( 3 a )$$

$$z ( t ) ∈ ℨ , u ( t ) ∈ 𝒰 , \qquad ( 3 b )$$

$$z ( 0 ) = {z}_{0} , z ( T ) = {z}_{F} , \qquad ( 3 c )$$

$$dist ( 𝔹 ( z ( t ) ) , {𝕆}^{[ m ]} ) \geq {d}_{min} , ∀ \text{?} \qquad ( 3 d )$$

$$\text{?} \text{indicates text missing or illegible when filed}$$

where the state z and input u are constrained under operation limits Z and U. B(z(t)) denotes the vehicle body at time t, and the vehicle is asked to maintain a safety distance dₘᵢₙ away from all obstacles O[m]. The stage cost c (.,.) can encode the amount of actuation, energy consumption, and time consumption. Problem (3(a)-(d)) can be solved efficiently by reformulating the collision avoidance constraints (3d) and discretizing with orthogonal collocation on finite elements.

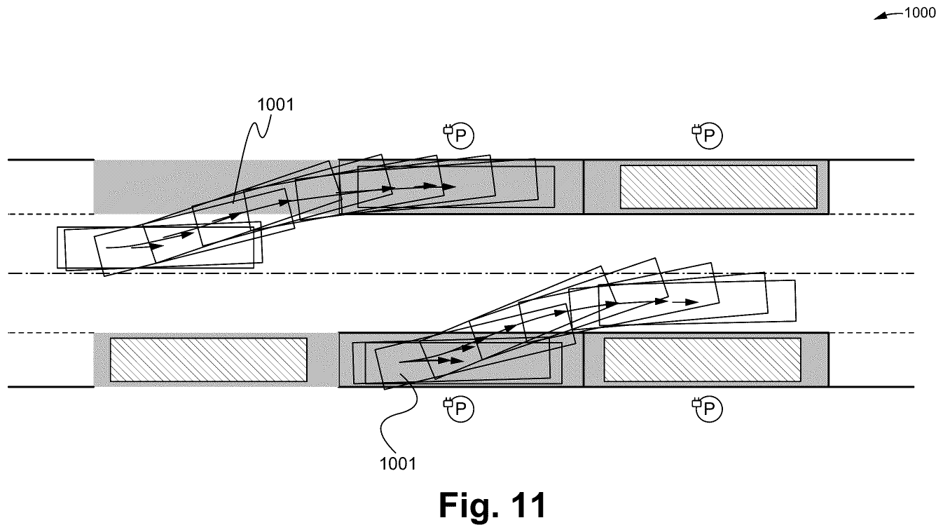

FIG. 11 shows the kinematically feasible, collision-free trajectories for buses A and C in FIG. 6 to enter and leave their charging spots in a Depot 1000. In this example, since the structure of the depot is known, and the transit ZEVs will always drive along dedicated lanes repetitively, the system can enumerate all possible maneuvers and generate the trajectories in advance as a library, and send them to buses according to the specific real-time scenario.

In some embodiments, the ZEV Digital Twin Platform 110, the Optimizer 110, the Depot Parking and the Charging Queue Management 115, or any combination thereof, is hosted in the cloud, such as on the Amazon Elastic Compute Cloud or the MicroSoft Azure Platform, to name only a few examples. In some embodiments, referring to FIGS. 2, 3, and 5, for example, any of the combination of the elements 101, 120, 125, and 130 (FIG. 2), 301, 350, 355, 359, and 361, and 370 (FIG. 3), and 301′, and 405, can be performed in the cloud. In some embodiments, the amount of processing power, memory, etc., is configurable for the application at hand, e.g., the number of buses in a fleet, the amount of data processing required for each application, the complexity of the optimization problems that are solved, the amount of processing that is performed on the vehicles (reducing the processing burden on the other components), etc. In some embodiments, some of the functions are performed in the cloud, while other functions are performed on other platforms.

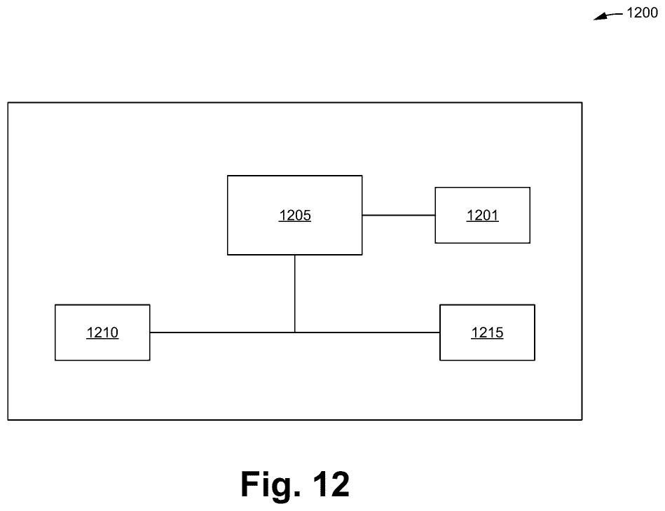

FIG. 12 is a block diagram of an element 1200 illustrative of the components described herein, including, but not limited to modules/sub-modules (e.g., ZEV Digital Twin Platform 101, Digital Twins Automated Learning 301′, Optimizer 110, Depot Parking Charging Queue Management Module 115, Yard Management Module 130, Planning and CAD/AVL Systems 125, Input Module 120, Input Module 321 Vehicle/Charger State 311, Feature Store 315, to name only a few examples), and any other components/sub-components described herein. Referring to FIG. 12, in some embodiments, each component includes one or more processors 1201 coupled to computer-readable media (memory) 1205 containing computer-executable instructions that when executed by the one or more processors 1201 perform the functionality of the components described herein. For example, the Optimizer 110 performs optimization when the processor 1201 performs the computer-executable instructions in the memory 1205. The memory 1205 is coupled to one or more input/output (I/O) ports 1210 and 1215, which in turn are coupled to other components over a bus or to external components over a network. In some embodiments, one or both of the I/O ports 1210/1215 comprise network interface cards. As one example, the element corresponds to Data Pull Jobs Module 305 in FIG. 3, and the I/O port 1210 is coupled to the Telematics Module 357, the CAD/AVL/RT Module 359, and the Yard Management Module 361, and the I/O port 1215 is coupled to the Raw Data Module 307. In some embodiments, one or both of the I/O Ports 1210/1215 are bi-directional, capable of both transmitting and receiving data. In some embodiments, inputs and outputs across I/O port 1210 and 1215 can come from the Web through APIs or published to the Web through APIs. It will be appreciated that data can be transmitted and received in other ways known to those skilled in the art.

In operation, systems and methods in accordance with some embodiments receive inputs to generate ZEV and electric battery data to generate vehicle and battery performance models. Based on a KPI, the models are used to assign work to the vehicles and to deploy the vehicles for charging, all to optimize the KPI. In some embodiments, the models are updated in real time, based on events, such as low block or plan adherence, that is, the actual performance does not correspond to the predicted performance.

It will be appreciated that the above embodiments are merely illustrative. For example, while the embodiments refer to electric buses, other electric vehicles are also contemplated. It will be readily apparent to one skilled in the art that various other modifications may be made to the embodiments without departing from the spirit and scope of the invention as defined by the appended claims.

What is claimed is:

1. A system for assigning work to and charging electric vehicles from a fleet electric vehicles, the system comprising:
a digital twin platform for generating behavior models for electric vehicles, charging stations for the electric vehicles, or both;
an assignment and strategy module for optimally assigning blocks and determining optimal charging strategies for the electric vehicles; and
a depot parking and management module for parking and charging the electric vehicles according to optimal charging strategies.

2. The system of claim 1, wherein the digital twin platform comprises a behavior model module for generating the behavior models, the behavior model module comprising an automated learning element to update the behavior models.

3. The system of claim 2, wherein the automated learning element updates the behavior models in real time.

4. The system of claim 2, wherein the models comprise physics-based models, neural network-based models, or any combination of both.

5. The system of claim 1, further comprising an input module coupled to the digital twin platform, the input module configured to transmit to the digital twin platform telematics information associated with the electric vehicles, the chargers, or any combination thereof.

6. The system of claim 1, further comprising a third-party input module coupled to the digital twin platform for transmitting traffic data, weather data, and maps data to the digital twins platform.

7. The system of claim 1, wherein the assignment and strategy module is configured to solve an optimization problem based on state of charge for electric batteries for the electric vehicles, initial and final state constraints for the electric vehicles, safety constraints for the electric vehicles, charging constraints for chargers at a depot, bus-to-block constraints, or any combination thereof.

8. The system of claim 1, wherein the assignment and strategy module is further configured to assign the blocks, determine the optimal charging strategies based on a price of electricity, a maximum power supply, the availability of chargers, or any combination thereof.

9. The system of claim 1, further comprising a replanning platform, the replanning platform comprising a prediction module coupled to an adaptive optimization module.

10. The system of claim 9, wherein the prediction module comprises a Deep Reinforcement Learning-Based Cost Prediction module with real-time feedback coupled to an Adaptive Optimization System using a real-time trigger.

11. The system of claim 1, wherein the digital twin platform, the assignment and strategy module, the depot parking and management module, or any combination thereof is hosted on one or more cloud platforms.

12. A method of efficiently utilizing electric vehicles in a transit fleet, the method comprising:
generating behavior models for the electric vehicles, vehicle charging stations, or both;
optimizing the performances of the electric vehicles, vehicle charging stations, or both based at least in part on vehicle constraints, charging constraints, or both; and
controlling the deployment and charging of the electric vehicles based on the behavior models.

13. The method of claim 12, further comprising generating a vehicle behavior model for each individual electric vehicle.

14. The method of claim 12, further comprising generating a vehicle behavior model for each type of vehicle.

15. The method of claim 12, wherein the behavior models are learning based.

16. The method of claim 12, wherein the optimizing are based at least in part on Deep Reinforcement Learning (DRL)-based cost prediction models.

17. The method of claim 16, wherein the DRL-based cost prediction models dynamically predict dispatching costs by considering vehicle states, operational parameters, and environmental conditions.

18. The method of claim 12, wherein optimizing comprises solving one or more optimization problems.

19. The method of claim 18, wherein solving the optimization problem is triggered by the occurrence of one or more events.

20. The method of claim 19, wherein the one or more events comprise any one or more of a low vehicle state of charge, scheduled intervals, and a detected discrepancy between planned and executed trips.

21. The method of claim 20, further comprising using artificial intelligence for real-time identification of trip execution status to generate vehicle operational adjustments in real time.

22. The method of claim 12, further comprising generating a plan to navigate one or more of the electric vehicles through a charging depot based on the optimal Key Performance Indicator.

23. The method of claim 16, wherein the DRL model is trained on at least historical vehicle data, General Transit Feed Specification (GTFS) Data, or both.

24. A method of efficiently utilizing electric vehicles in a transit fleet, the method comprising:
collecting sets of electrical vehicle, electrical charger data, or both for generating performance models for electric vehicles in a fleet of electric vehicles, electrical vehicle chargers, or both converting, by a data convert, the sets of electrical vehicle data, the electrical charger data, or both, into standardized data for use in behavior models;
generating or updating, from the standardized data, the performance models;
using the performance models to predict vehicle performance, electrical charger performance, or both;
storing the predicted vehicle performance, predicted electrical charge performance in a prediction store;
determining a key performance index (KPI) for the utilizing the electric fleet; and
generating work schedules for the electric vehicles along their respective routes based on contexts, charging schedules, or both, to obtain a KPI within a predetermined range.

25. The method of claim 24, wherein the sets of electrical vehicle data are collected, at least in part, by onboard electronics on the vehicles, and transmitted by the onboard electronics to a data pull module.

26. The method of claim 25, wherein the collecting and transmitting are both performed in real time.

27. The method of claim 26, wherein at least some of the electric vehicles are autonomous vehicles, the method further comprising:
translating the charging schedules into instructions for navigating the autonomous vehicles within a charging station; and
transmitting the instructions to the autonomous vehicles.

28. The method of claim 24, further comprising receiving traffic data, weather data, maps data, or any combination thereof, for generating the performance models.

29. The method of claim 24, wherein the contexts comprise weather along a route, traffic, maps, and state of charge of a vehicle.

30. The method of claim 24, wherein the converting comprises:
determining planned landmarks from planned data;
pairing time and location planned data with real-time data;
determining landmarks in real time and adjusting the planned data to correspond to the real-time data; and
identifying features between landmarks to correlate real-time data with planned data.

31. The method of claim 30, further comprising using the features, time, and location data to update the models.
